(19) United States
(12) Patent Application Publication
(10) Pub. No.: US 2009/0269566 A1
(43) Pub. Date: Oct. 29, 2009

(54) PRE-STRETCHED MULTI-LAYER STRETCH FILM

(75) Inventors: George N. Eichbauer, Bishop, GA (US); Alexander Tukachinsky, Jefferson, MA (US)

Correspondence Address: BARNES & THORNBURG LLP, 11 SOUTH MERIDIAN, INDIANAPOLIS, IN, 46204, US

(73) Assignee: Berry Plastics Corporation, Evansville, IN (US)

(21) Appl. No.: 12/428,345

(22) Filed: Apr. 22, 2009

Related U.S. Application Data
(60) Provisional application No. 61/047,137, filed on Apr. 23, 2008.
(60) Provisional application No. 61/060,180, filed on Jun. 10, 2008.

(51) Int. Cl. B32B 27/32; B32B 27/08

(52) U.S. Cl. 428/220; 428/516

(57) ABSTRACT

A multi-layer stretch film includes multiple layers of polyolefins. A multi-layer stretch film may include two or more layers including a cling layer, a non-cling layer, or a core layer. A multi-layer stretch film includes a pre-stretched multi-layer stretch film having two or more layers.

This application claims priority under 35 U.S.C. §119(e) to U.S. Provisional Application Ser. No. 61/047,137, filed Apr. 23, 2008 and U.S. Provisional Application Ser. No. 61/060,180, filed Jun. 10, 2008, both of which are expressly incorporated by reference herein.

### BACKGROUND

The present disclosure relates to multi-layer stretch film, and to a method of making the same. More particularly, the present disclosure relates to a polymeric co-extruded multi-layer film and a process for making the same.

Stretch films are designed to stretch in response to an applied force. Some stretch films are capable of stretching to a large extent; they are highly stretchable. The amount a film can stretch may be described by a percentage of the films original length. For example, when pulled from both ends, a film may stretch so that it is twice its original length. This film could be described as having stretched 100%. Stretch films may be designed to stretch to some maximum percentage of their original length. For example, some stretch films are designed to stretch up to 300% of their original length. Once the film has reached that length, the film may be described as fully stretched. The film may be capable of additional stretching, but that stretching will occur in response to forces greater than those forces used to stretch the film to its fully stretched state.

Pre-stretched stretch films are stretched prior to the consumer stretching the film. They are useful in applications in which the consumer may not be able to fully stretch the film. For example, one use of pre-stretched stretch films is wrapping pallets of goods prior to shipping. In many cases, this task is done by hand because a facility may not have a pallet wrapping machine. Therefore, a worker will wrap the pallet of goods by walking around the pallet holding a film dispenser in his or her hand. A worker may not exert large or precise forces on the film. Therefore, if the film required large and precise stretching, the worker may not be able to apply the film properly to the pallet of goods. When stretching the film entails stretching the film by about 20 to 50%, the worker will be able to wrap the goods properly. A pre-stretched film may also be applied with reduced worker effort, a benefit particularly to high volume applications.

### SUMMARY

According to the present disclosure, a multi-layer stretch film is described having multiple layers of polyolefins. In illustrative embodiments, the multi-layer stretch film includes a cling layer, a non-cling layer, and a core layer.

In illustrative embodiments, the multi-layer stretch film is pre-stretched and includes a cling layer, a non-cling layer, and a core layer. In one embodiment, pre-stretching increases the gauge normalized puncture resistance of the film by about two times.

In illustrative embodiments, the pre-stretched multi-layer stretch film includes two layers, the first layer having a spherulite-like microcrystalline orientation and the second layer having a row-nucleated microcrystalline orientation. In one embodiment, the pre-stretched multi-layer stretch film has a gauge normalized puncture resistance greater than about 450 g/mil.

In illustrative embodiments, the pre-stretched multi-layer stretch film includes three layers, one layer having a row-nucleated microcrystalline orientation and a second layer having a spherulite-like or elongated spherulite-like microcrystalline orientation. In one embodiment, the third layer may have cling properties.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is an cross-sectional view of a pre-stretched stretch film including a cling layer, a non-cling layer, and a core layer; and

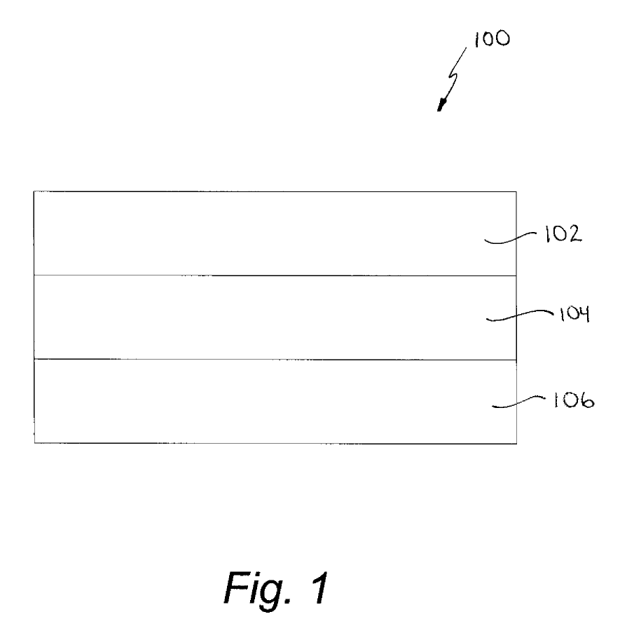

FIG. 2 is a flow diagram depicting a method of manufacturing a pre-stretched stretch film.

### DETAILED DESCRIPTION

A pre-stretched multi-layer stretch film is described having a first layer having a spherulite-like microcrystalline orientation and a second layer having a row-nucleated microcrystalline orientation, wherein the pre-stretched multi-layer stretch film has a gauge normalized puncture resistance greater than about 450 g/mil as determined by ASTM D-1709. In one embodiment, the pre-stretched multi-layer stretch film includes about 80 to about 93% LLDPE, about 5 to about 8% LDPE, and about 2 to about 15% a cling promoting polymer. In another embodiment, the cling promoting polymer is selected from a group consisting of an elastomer, a plastomer, and an EMA copolymer.

In illustrative embodiments, a pre-stretched multi-layer stretch film includes first layer including less than 1% of a strain hardened polymer and a second layer including about 10 to about 50% of the strain hardened polymer. In another embodiment, the pre-stretched multi-layer stretch film is from about 0.10 mil to about 0.80 mil in thickness. In yet another embodiment, the pre-stretched multi-layer stretch film is a pre-stretched hand-wrap film having an initial modulus and a later modulus after being stretched by about 25 to about 50%, wherein the later modulus is 50% greater than the initial modulus.

In illustrative embodiments, a pre-stretched multi-layer stretch film 100 includes a cling layer 106, a non-cling layer 102, and a core layer 104 interposed between the cling layer 106 and the non-cling layer 102. In one embodiment, the pre-stretched multi-layer stretch film 100 has a gauge normalized puncture resistance greater than about two times the gauge normalized puncture resistance of an input film from which the pre-stretched multi-layer stretch film 100 was derived.

In illustrative embodiments, the core layer 104 of the pre-stretched multi-layer stretch film 100 includes a composition that resists orientation via rapid molecular relaxation. In one embodiment, the core layer 104 of the pre-stretched multi-layer stretch film 100 includes a blend of linear low density polyethylene (LLDPE) having a MI of less than or about equal to 2. In another embodiment, the core layer 104 of the pre-stretched multi-layer stretch film 100 includes a blend of about 90% LLDPE having a MI of less than or about equal to 1 and 10% LLDPE having a MI of less than or about equal to 2.5. In yet another embodiment, the core layer 104 is substantially free of strain hardened polymer.

The term LLDPE is used to describe a copolymer of ethylene and an alpha olefin comonomer made through Ziegler-Natta or metallocene single site catalyzed reaction. LLDPE also includes polymers made through non-metallocene or post-metallocene catalyzed reactions resulting in a copolymer of ethylene and an alpha olefin copolymer. LLDPE includes copolymers made with various alpha olefin monomers including 1-butene, 3-methyl-1-butene, 3-methyl-1-pentene, 1-hexene, 4-methyl-1-pentene, 3-methyl-1-hexene, 1-octene or 1-decene. The alpha olefin comonomer may be incorporated from about 1% to about 20% by weight of the total weight of the polymer, preferably from about 1% to about 10% by weight of the total weight of the polymer. Reference may be made to U.S. Pat. Nos./U.S. Publ. Nos. 3,645,992, 4,011,382, 4,205,021, 4,302,566, 6,184,170, 6,919,467 and 2008/0045663 for examples of resins which may be particularly useful herein.

In illustrative embodiments, the core layer 104 comprises LLDPE. In one embodiment, the core layer 104 comprises octene-LLDPE with a MI of about 1. In another embodiment, the core layer 104 comprises octene-LLDPE with a MI of about 0.7 to about 1.2. In another embodiment, the core layer 104 comprises octene-LLDPE with a MI of about 1 blended with octene-LLDPE with a MI of about 2.4. In yet another embodiment, the core layer 104 comprises 90% octene-LLDPE with a MI of about 1 blended with 10% octene-LLDPE with a MI of about 2.4. In one embodiment, the core layer 104 comprises a composition or blend having a MI of less than about 2. In another embodiment, the LLDPE has a density of about 0.9 g/cm³ to about 0.94 g/cm³. In yet another embodiment, the LLDPE has a density of about 0.92 g/cm³.

In illustrative embodiments, the core layer 104 is substantially free of low density polyethylene (LDPE). As used herein, LDPE is defined as a polyethylene polymer with a density in the range of about 0.91 g/cm³ to about 0.93 g/cm³. LDPE may be polymerized through a free radical polymerization and have a predetermined degree of short and long chain branching. The term LDPE is intended to include high pressure low density polyethylene (HPLDPE) polymerized through a high pressure free radical polymerization. LDPE may strain harden when oriented due to its branched molecular structure. As used herein, substantially free of LDPE means that the concentration of the LDPE within the core layer 104 is less than about 1% by weight.

In illustrative embodiments, the pre-stretched multi-layer stretch film 100 includes a non-cling layer 102 that includes less than or about 50% of a strain hardened polymer. In one embodiment, the non-cling layer 102 comprises a blend of low density polyethylene (LDPE) and linear low density polyethylene (LLDPE). In another embodiment, the non-cling layer 102 includes less than or about 50% LDPE. In another embodiment, the non-cling layer 102 includes LDPE having a MI of about 3 to about 8. In another embodiment, the non-cling layer 102 includes LDPE having a density of about 0.92 g/cm³. In one embodiment, the non-cling layer 102 comprises an octene-LLDPE with a MI of about 1 blended with a LDPE having a MI of about 7. In another embodiment, the non-cling layer 102 comprises a blend of LLDPE and LDPE wherein the LLDPE comprises about 65% of the blend and the LDPE comprises about 35% of the blend. In another embodiment, the non-cling layer 102 includes LDPE and the core layer 104 is substantially free of LDPE.

In illustrative embodiments, the pre-stretched multi-layer stretch film 100 includes a cling layer 106. In one embodiment, the cling layer 106 comprises an ethylene methyl acrylate (EMA) copolymer. The EMA copolymer is a reaction product of two primary monomers and the ratio of the amount of either monomer may be adjusted. In one embodiment, the cling layer 106 comprises an EMA copolymer with a MI from about 3 to about 7. In another embodiment, the cling layer 106 comprises an EMA copolymer with a density in the range of about 0.93 g/cm³ to about 0.96 g/cm³. In one embodiment, the EMA copolymer includes about 15% to about 35% methyl acrylate units and from about 65% to about 85% ethylene units. In one embodiment, the EMA copolymer includes about 24% methyl acrylate units and about 76% ethylene units. In one embodiment, the cling layer 106 consists essentially of EMA copolymer.

As used herein, the term microcrystalline orientation refers to regular packing of polymer chains within a polymeric material. Polymers may be characterized as either crystalline or amorphous. Crystalline polymers include microcrystalline regions and amorphous polymers do not. As used herein, crystalline polymers include microcrystalline regions surrounded by amorphous regions. Microcrystalline regions may form in response to the intermolecular and intra-molecular hydrogen bonding and van der Waals attractive forces between the polymer chains. The crystallinity of a polymer refers to the extent of regular packing of molecular chains. Microcystalline orientation refers to the alignment of the microcrystalline regions with respect to each other. Therefore, an oriented polymer is a crystalline polymer that has aligned microcrystalline regions.

The orientation exhibited by the microcrystalline regions can be further described. For example, microcrystalline regions can be aligned in row-nucleated microcrystalline orientations with non-twisted lamellae, row-nucleated microcrystalline orientations with twisted lamellae or spherulite-like microcrystalline orientations.

As used herein, a spherulite-like microcrystalline orientation includes spherical semi-crystalline regions characterized by plates of orthorhombic unit cells called crystalline lamellae. These ordered plates are dispersed amongst amorphous regions, wherein even a completely spherulized polymer is not fully crystalline. A spherulite-like microcrystalline orientation will exhibit birefringence due to its high degree of anisotropic order and crystallinity. The process of spherulization starts on a nucleation site and continues to extend radially outwards until a neighboring spherulite is reached. This explains the spherical shape of the spherulite. The presence of spherulites in a polymer changes the properties of the polymer with respect to crystallinity, density, tensile strength and modulus of elasticity. Specifically, each of these properties increases with increasing spherulite content.

The presence of polymers which do not tend to form spherulite-like microcrystalline orientations may inhibit the formation of spherulites or cause an alternative orientation to form. With this interference, the corresponding increase in crystallinity, density, tensile strength and modulus of elasticity may not be observed. In one embodiment, the pre-stretched multi-layer stretch film 100 includes at least one layer which strongly exhibits a spherulite-like microcrystalline orientation. In another embodiment, the layer which strongly exhibits spherulite-like microcrystalline orientation is substantially free from polymers which do not form spherulite-like microcrystalline orientation.

As used herein, row-nucleated microcrystalline orientations include aligned crystalline lamellae, wherein the lamellae are either twisted or non-twisted. The lamellar arrangement is believed to originate from the high-molecular weight fraction of the polymer that orients into fibrils in the film extrusion direction (MD) during the film blowing or pre-stretching. These fibrils can act as nuclei for further crystallization. Since the lamellae grow perpendicular to the primary nuclei, orientation measurements in row-nucleated microcrystalline orientation blown films may show a preferential orientation in the direction perpendicular to MD.

As used herein, twisted lamellae morphology is when a row-nucleated microcrystalline orientation exhibits intertwined lamellae having an interlocked lamellar assembly instead of well-separated rows (non-twisted). The interlocking lamellae may include a boundary in which lamellae from different rows meet and are strongly connected or overlapped by the twisted growth. This orientation results in a strong increase in the MD tear resistance and MD tensile strength, but also results in a decrease in the TD tear resistance, TD tensile strength, and puncture resistance. Reference is made to Zhang et al. Polymer 45 (2004) 217-229, which is hereby incorporated by reference herein, for disclosure relating to microcrystalline orientation.

As used herein, the term strain hardening is an increase in hardness and strength caused by plastic deformation. Plastic deformation is a permanent change in shape. Plastic deformation has the nanoscopic effect of increasing the material's entanglement density. As the material becomes increasingly saturated with new entanglements, a resistance to deformation develops. This resistance to deformation manifests itself as increased hardness and strength. This observed strengthening is referred to as strain hardening. In one aspect, strain hardening behavior in polymers is associated with the presence of long-chain branching or ultra high molecular weight chains in the polymer, such as those that may be found in a crosslinked polymer.

In illustrative embodiments, the pre-stretched multi-layer stretch film exhibits a significant increase in Young's modulus (modulus) upon being finally stretched. As used herein, final stretching (finally stretched) is that stretching which would occur as the end-user stretches the pre-stretched multi-layer stretch film during use. As used herein, the term strain is the deformation of a physical body under the action of applied forces. Specifically, deformation may be the elongation due to stretching and decrease in cross-sectional area associated therewith.

In one embodiment, the pre-stretched multi-layer stretch film has a first modulus and a second modulus subsequent to being strained about 25 to about 50%, wherein the second modulus is greater than the first modulus by at least about 150%. In another embodiment, the pre-stretched multi-layer stretch film has a first modulus and a second modulus subsequent to being strained about 50 to about 200%, wherein the second modulus is greater than the first modulus by at least about 150%.

As used herein, the term rapid molecular relaxation refers to an expedited rate by which polymer chains progress towards an equilibrium condition from a non-equilibrium condition. In one aspect, the non-equilibrium condition includes microcrystalline orientation and the equilibrium condition includes the absence of such microcrystalline orientation. In another aspect, the non-equilibrium condition is an elevated entanglement density state and the equilibrium condition is a structure dependent normal entanglement density state. In yet another aspect, LLDPE exhibits rapid molecular relaxation due to its short chain branching, which prevents an increase in the entanglement density. While LLDPE may exhibit rapid molecular relaxation, it still may acquire a microcrystalline orientation, such as an elongated spherulite-like microcrystalline orientation. This orientation may exhibit increased tear resistance, but this behavior is distinct from the term strain hardening, as used herein.

While not being limited to any particular theory, it is believed that the microscopic characteristics of the oriented film substantially contribute to the performance characteristics described herein. The microcrystalline orientation of LLDPE, when used within the scope of the materials and processes described herein, can be described as having a spherulite-like microcrystalline orientation. Structures exhibiting spherulite-like microcrystalline orientations are known to exhibit balanced MD and TD tear resistances.

In illustrative embodiments, the cling layer 106 comprises a blend of polypropylene or LLDPE and an elastomer or a plastomer. As used herein, a plastomer is a polyolefin comprising an ethylene-octene copolymer having a MI from about 2 to about 4, a density from about 0.86 g/cm³ to about 0.9 g/cm³). In one embodiment, the plastomer has an MI of about 3 and a density of about 0.88 g/cm³. As used herein, the elastomer is copolymer having a MI from about 3 to about 18 and a density from about 0.85 g/cm³ to about 0.88 g/cm³. In one embodiment, the elastomer has an MI of about 8 and a density of about 0.86 g/cm³. In another embodiment, the elastomer is a copolymer of propylene and ethylene comprising about 12% to about 16% ethylene by weight and 84% to about 88% propylene.

In illustrative embodiments, the cling layer 106 consists essentially of an elastomer or a plastomer. In another embodiment, the cling layer 106 includes a blend of LLDPE and an elastomer. In another embodiment, the cling layer 106 includes a blend of LLDPE and a plastomer. The plastomer or elastomer content may vary based on the desired cling properties of the film. In one embodiment, the plastomer comprises from about 10% to about 100% of the cling layer 106. In one embodiment, the plastomer comprises from about 25% to about 75% of the cling layer 106. In another embodiment, the elastomer comprises from about 10% to about 100% of the cling layer 106. In another embodiment, the elastomer comprises from about 30% to about 80% of the cling layer 106.

In illustrative embodiments, a pre-stretched multi-layer stretch film 100 includes a cling layer 106, a non-cling layer 102 exhibiting a first microcrystalline orientation, and a core layer 104 exhibiting a second microcrystalline orientation. In one embodiment, the first microcrystalline orientation is a row-nucleated microcrystalline orientation and the second microcrystalline orientation is a spherulite-like or elongated spherulite-like microcrystalline orientation. In another embodiment, the first microcrystalline orientation is a result of a blend of LDPE and LLDPE orienting in response to pre-stretching. In one embodiment, the blend may include about 10 to about 50% LDPE and about 50 to about 95% LLDPE by weight. In another embodiment, the blend may include about 35% LDPE and about 65% LLDPE by weight. In another embodiment, the second microcrystalline orientation is a spherulite-like or elongated spherulite-like microcrystalline orientation that would result from pre-stretching LLDPE, that LLDPE being substantially free of materials that promote the formation of row-nucleated microcrystalline orientation. For example, the second microcrystalline orientation may include less than 1% LDPE.

In illustrative embodiments, a pre-stretched multi-layer stretch film 100 includes a cling layer 106, a non-cling layer 102 have a first entanglement density, and a core layer 104 exhibiting a second entanglement density. In one embodiment, the first entanglement density is 50% higher than the second entanglement density. In another embodiment, the first entanglement density results from a polymer blend including long-chain branched polymers being pre-stretched. In another embodiment, the second entanglement density results from a polymer blend essentially free of long-chain branched polymers being pre-stretched.

Entanglements in long-branched LDPE cause its strain-hardening and orientation during film extrusion and pre-stretching. Conversely, absence of long branches in LLDPE allows its molecules to return more quickly to its unoriented state prior to crystallization.

In one embodiment, a pre-stretched multi-layer stretch film includes at least two layers, one of which contains a strain-hardening polymer (e.g. LDPE or a blend thereof, while the other does not. As a result, the degree of microcrystalline orientation of the layer containing a strain-hardening polymer is greater than the degree of microcrystalline orientation of the layer which does not contain a strain-hardening polymer after pre-stretching the film.

In illustrative embodiments, a pre-stretched multi-layer stretch film includes at least two layers, a first layer having a twisted lamellae morphology and a second layer which is substantially free of a twisted lamellae morphology. In one embodiment, the twisted lamellae morphology includes about 10 to about 50% of a long-chain branched polymer. In another embodiment, the second layer includes less than 1% of a long-chain branched polymer.

The thickness of each layer may be described as a percentage of the entire pre-stretched multi-layer stretch film 100 thickness. In one embodiment, the cling layer 106 comprises about 15% of the pre-stretched multi-layer stretch film 100 thickness, the non-cling layer 102 comprises about 15% of the pre-stretched multi-layer stretch film 100 thickness, and the core layer 104 comprises about 70% of the pre-stretched multi-layer stretch film 100 thickness. In another embodiment, the pre-stretched multi-layer stretch film 100 is about 0.10 mil to about 0.80 mil in thickness (1 mil= 1/1000 inch). In one embodiment, the thickness of an input film is about 0.5 mil to about 2.5 mil (50 to 250 gauge) and the thickness of the pre-stretched multi-layer stretch film 100 is about 0.2 mil to about 1 mil (20 to 100 gauge). In one embodiment, the pre-stretched multi-layer stretch film 100 includes a core layer 104 that is about 0.14 mil to about 0.7 mil in thickness. In another embodiment, the cling layer 106 and the non-cling layer 102 may be about 0.03 mil to about 0.15 mil in thickness.

As described herein, one application of pre-stretched stretch films is hand-wrapping goods. While there are several reasons for wrapping the pallet of goods, one reason is to keep the goods firmly secured on the pallet and to prevent shifting of the goods during shipping. For these reasons, a fully stretched film may be applied to the goods. If the worker does not fully stretch the film, it may stretch more after it is applied to the goods (i.e. during shipment). For example, when goods jostle during shipment, they may exert enough force on the film to cause it to stretch. For a film that is not fully stretched, relatively light forces may cause the film to stretch. If the film does stretch, it may no longer properly secure the goods on the pallet. This may result in the goods rearranging, being lost, or becoming damaged during shipment. A pre-stretched film is designed so that it can be pre-stretched by machine prior to the consumer or the worker using the film. Therefore, it may be easier for the consumer or the worker to stretch the film to its fully stretched state.

Because stretch films are typically not reused, the cost of the film and the waste generated after use are factors that contribute to consumers' choice of which film to use. To reduce waste and cost, the amount of film used may be minimized. One way to minimize the amount of film used is to improve the film's performance. For example, the worker may use less high performance film to wrap a pallet of goods compared to if he or she was using a low performance film. Another way to reduce waste and cost is to decrease the thickness and weight of the film while maintaining its performance. For example, a given application may call for certain film specifications, waste and cost may be minimized by using the thinnest film meeting those specifications. The pre-stretched films disclosed herein are designed to have particularly good performance with very little thickness. These films may be referred to as light gauge films because they may be from about 0.10 mil to about 0.80 mil thick.

As used herein, the term pre-stretched describes films that are stretched during their manufacture. The stretching that occurs during the manufacture is called pre-stretching because it occurs before the consumer uses and stretches the film. One aspect of the present disclosure is that pre-stretching improves the physical characteristics of the film (puncture resistance, tear resistance, strength, and/or elongation properties, etc.) while decreasing the film's thickness. Pre-stretching is an additional step or process that occurs during the manufacture of these films. Both machine-direction orientation processes and cold-drawing processes are within the scope of the term pre-stretching. Machine-direction orientation processes involve pre-heating the film and cold-drawing involves stretching the film without heating.

After a film is extruded from a blown-film line, the resulting stretch film is called an input film. In one embodiment, the input film is capable of stretching greater than 300%. The input film can either be wound temporarily on a roll or fed directly into a pre-stretching machine. After pre-stretching, the film is an output film and it may be wound on a roll in a manner so that it is ready to be used by a consumer. Additional steps may be performed during manufacture of the film such as corona discharge, chemical treatment, flame treatment, etc., to modify the printability or ink receptivity of the surface(s) or to impart other characteristics to the film.

Pre-stretched films may also be used within machine-wrap applications. For example, many wrapping machines or automated wrapping processes were designed to accommodate films stretching from about 150 to about 200%. It may not be possible for these machines to stretch a film by more than about 200%. As discussed herein, an input film may be capable of stretching by more than about 300%. Therefore, pre-stretching the input film during manufacturing of the film results in a film that can be used on these machines.

A pre-stretched film for hand-wrapping and one for machine-wrapping may differ in the amount of stretch remaining in the films after the pre-stretching. In one embodiment a pre-stretched film for machine-wrapping applications may be fully stretched by stretching less than about 150 to about 200%. In another embodiment, a hand-wrap application may be fully stretched by stretching less than about 20 to about 50%. It should be recognized some stretch film may be similarly suited for both hand-wrapping and machine wrapping. However, an embodiment designed for a pre-stretched machine-wrap application may be somewhat different from an embodiment designed for hand-wrap applications.

In illustrative embodiments, a stretch film for wrapping goods may cling to itself without sticking to the goods being wrapped. In one embodiment, the exterior surface of the film may not be sticky towards dirt, debris, or to the exterior surfaces of films covering neighboring goods. In another embodiment, the cling surface and the non-cling surface of a film may be designed together. For example, the first surface, a cling surface, may be designed so that it clings to a second surface, a non-cling surface. When the stretch film is wrapped around goods, it is the cling surface which faces the goods and the non-cling surface which faces out. Consequently, overlapping the film on itself will result in the cling surface contacting the non-cling surface.

The extent to which the cling surface and the non-cling surface adhere to each other is called the cling force and may be an important property of a film. While cling and non-cling surfaces can be imparted on a film having a single composition throughout, disclosed herein is a multi-layer film which has a cling layer 106 with a cling surface and non-cling layer 102 with a non-cling surface. Since the interaction between these two surfaces depends on the properties of both surfaces, the materials used within the cling and non-cling layer 102 are selected as a pair. For example, a non-cling layer 102 may be selected which is particularly resistant to dirt accumulation. Designing a film within the scope of this example may require the inclusion of a very aggressive cling layer 106. In another example, a film having a cling layer 106 and a non-cling layer 102 that exhibit a very large cling force may result in a roll of film not unwinding properly. In illustrative embodiments, non-cling and cling layers are designed to balance the independent characteristics of each surface with the characteristics of the interaction between the two layers (i.e. the cling force).

In illustrative embodiments, the thickness of the cling layer 106 and non-cling layer 102 may be selected so that the resulting pre-stretched multi-layer stretch film 100 has uniform surfaces after pre-stretching. Pre-stretching reduces the thickness of the film and each layer is correspondingly reduced in thickness. In one embodiment, the thickness of the non-cling and cling layers, as described herein, may be selected so that the surfaces of the film can possess homogeneous cling and non-cling properties. In one aspect, the tear strength and puncture resistance of the film may depend on the thickness of the core layer 104. Therefore, the thickness (absolute and as a percentage) maybe balanced against the physical properties of the film.

While specific polymer compositions are referred to herein, one of ordinary skill in the art will appreciate that polymers or polymer blends with substantially equivalent physical properties may be substituted; yet remain within the scope and spirit of the present disclosure. In particular, those polymers having substantially equivalent melt indexes (MI) and flow ratios (FR) may be suitable. One of ordinary skill in the art will appreciate that MI (units herein of g/10 min) is an indication of molecular weight, wherein higher MI values typically correspond to low molecular weights. At the same time, MI is a measure of a melted polymer's ability to flow under pressure. FR is used as an indication of the manner in which theological behavior is influenced by the molecular weight distribution of the material. While not being limited to theory, MI and FR are indirect predictors of the microcrystalline orientation which may be formed in the polymer.

In illustrative embodiments, the physical properties the film exhibits with respect to tear resistance and puncture resistance may be influenced by the core layer 104. Through experimentation, it has been established that certain non-cling and cling layers may also influence these properties. While not being limited to a particular theory, it is believed that LDPE contributes strongly to the orientation within the film during pre-stretching. In one embodiment, the concentration of LDPE in the core layer 104 is less than about 1%. This may result in the core layer 104 having a predetermined first degree of orientation. In one embodiment, the first degree of orientation may be less than the second degree of orientation found in the non-cling layer 102.

In one aspect, levels of LDPE of greater than about 1% in the core layer 104 may contribute to diminished puncture resistance. In one aspect, the present disclosure describes that a balance of puncture resistance and tear resistance is achieved by maintaining the concentration of LDPE in the core layer 104 at a level of less than 1%. In another aspect, the core layer 104 may be substantially free of a strain hardened polymer (i.e. branched LDPE). Instead, the core layer 104 may be comprised of materials that orient less during pre-stretching, such as those materials that exhibit rapid molecular relaxation, (i.e. LLDPE). For example, LLDPE orients during pre-stretching, but the extent of this orienting is lower due to the comparatively short side-chains.

The polymer orientation within a film may increase tear resistance in the transverse direction, but it may also reduce tear resistance in the machine direction and/or the puncture resistance. One aspect of the present disclosure is a film having a core layer 104 having first degree of orientation and a non-cling layer 102 with a second degree of orientation. In one embodiment, the first degree of orientation is greater than the second degree of orientation. In illustrative embodiments, the tear resistance in the machine direction, the tear resistance in the transverse direction and puncture resistance may be simultaneously improved by the pre-stretching process. In this respect, described herein is a film with a balance between layers having different degrees of orientation induced by pre-stretching, the film having performance characteristics exceeding those previously designed.

The extent to which a film is oriented may be determined by a number of analytical techniques. One technique is to measure the change in size of a given film upon heating. The heating provides energy sufficient to rearrange and relax the polymer chains from their oriented states. This relaxation results in the film changing shapes. Oriented films will exhibit shrinkage in the machine direction and will swell in the transverse direction. The extent by which a film swells and shrinks may be used as a comparative method for evaluating the extent of orientation. Other analytical techniques which may be used to establish the extent of orientation include polarized light spectroscopy (i.e. infrared dichroism, trichroism and birefrengence), x-ray methods (i.e. small angle x-ray scattering and wide angle x-ray scattering), and microscopy (i.e. scanning electron microscopy, transmission electron microscopy, and atomic force microscopy).

For any of the listed polymer compositions, numerous grades of polymers may be used for each of the layers. Depending on the actual grade used, a film may have distinct performance characteristics. For example, a stretch film could be made in which the non-cling layer 102 is made of a blend of LDPE having a first MI and FR and LLDPE having a second MI and FR. If a second blend is made with different grades of LDPE having a third MT and FR and LLDPE having a fourth MI and FR, the performance of the second blend as a non-cling layer 102 may be predicted in a limited way by the similarity of the first and the third MI and FR and the second and the fourth MI and FR. Furthermore, the MI and FR of the blended compositions may be predictive.

Comparison of the MI and FR may not always dispositive in assessing the similarity between two polymer compositions. In this respect, the polymer grade may substantially affect the properties of a given layer within the film. Based on the foregoing, a general statement that assumes the properties of two polymer compositions are inherently equivalent because the two polymers are made from the same monomers is obviously deeply flawed and a gross oversimplification of the science and art of making films.

One way to compare the similarity between two films is to examine their overall properties, while keeping in mind the underlying composition. Regarding the composition of the distinct layers, an evaluation of the intrinsic properties of each of the polymers used in each layer should be done within the scope of a full comparison. For the example provided herein, a determination of the molecular weight and methyl acrylate to ethylene ratio may be influential in determining whether the EMA copolymer is suitable for a cling layer with respect to a given non-cling layer 102. Similarly, when blends of polymers are used, the properties of the resulting blend may contribute more to the suitability of that composition for a layer of the film than the identity of the individual polymers.

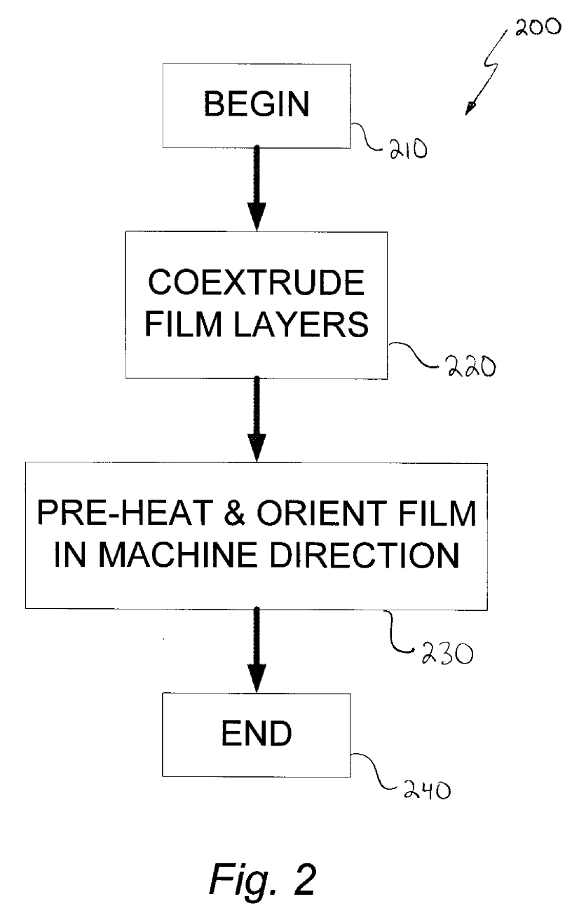

FIG. 2 is a flow diagram depicting a method of manufacturing a film in accordance with one embodiment of the present invention. The method 200 begins at step 210. At step 220, the non-cling layer 102, the core layer 104 and the cling layer 106 are coextruded, for example, using blown-film extrusion. At step 230, an input film is pre-stretched. In one embodiment, the input film is pre-heated to an appropriate temperature in accordance with such process. For example, the input film may be preheated using a heated roller maintained at a temperature between about 120 degrees to about 220 degrees Fahrenheit.

Once pre-heated, the input film is oriented in the machine direction resulting in an output film. For example, the output film may be about 25% to about 500% longer than the input film. In one embodiment, a draw ratio of between about 1.25:1 to about 6.00:1 may be used to pre-stretch the input film. In one embodiment, the input film is pre-stretched to between about 50% to about 350%. In another embodiment, a draw ratio of between about 1.50:1 to about 4.50:1 may be used to pre-stretch the input film. At step 240, the method 200 ends.

As described herein, pre-stretching can improve the physical characteristics of a film (puncture resistance, tear resistance, strength, and elongation properties, etc.). In manufacturing a pre-stretched stretch film, molten polymers are extruded through an annular slit die to form a thin walled tube. Air is introduced via a hole in the center of the die to expand the tube. Mounted on top of the die, a high-speed air ring blows onto the hot film to cool it into a more rigid state. The tube of film then continues upwards, continually cooling, until it passes through a plurality of nip rolls where the tube is flattened and cooled. Reference is made to U.S. Pat. No. 3,265,789, issued Aug. 9, 1966, to Hofer, which patent in its entirety is hereby incorporated by reference herein, for disclosure regarding blown-film extrusion technology. While the processes and compositions are described in particular relation to blown-film and blown-film processes, one of ordinary skill in the art will recognize that the disclosure herein may be equally suitable for co-extrusion techniques, such as cast co-extrusion.

The pre-stretching step includes feeding the film between a stretch nip and a first roll. Illustratively, the first roll is rotating at a first speed. As the film separates from the first roll, it is drawn to a second roll, which is rotating at a second speed. The pre-stretching occurs because the diameter and the rotational speed of the second roll makes the film that is in contact with that roll travel at a tangential speed greater than the tangential speed of the film on the first roll. The ratio of these tangential speeds determines the extent to which the film is stretched. For example, if the tangential speed of the second roller is two times greater than the tangential speed of the first roller, the film would he stretched by 100%.

The degree of stretch may similarly be called a stretch ratio (the ratio of the length of the output film to the length of the input film), which in this example would be 2:1. The rotational speed of the two rollers can be adjusted so that the desired stretch ratio is achieved. Similarly, additional rollers may be used in series to accomplish a predetermined amount of stretch. For example, a first roller may have a tangential speed of 500 feet per minute (fpm), a second roller may have a tangential speed of 1000 fpm, and a third roller may have a tangential speed of 2000 fpm.

As the film comes into contact with the second roller, the input film is stretched by 100%. Upon coming into contact with the third roller, the film is stretched an additional 100%. The output film would therefore be stretched 300% compared to the input film. In one embodiment, after leaving the stretching rollers, the film may be allowed to anneal on one or more rollers traveling at lower tangential speeds than the final stretching roller. For example the film may be allowed to relax or shrink by 20% prior to placing on its final roll. Subsequent to the annealing step, the output film is referred to as the pre-stretched multi-layer stretch film 100. In one embodiment, the method 200 does not include an annealing step

As the film is stretched, the thickness of the film decreases. The machines used for pre-stretching the film are designed to minimize the neck-in. Neck-in is the term of art which is used to describe the extent to which a film will decrease in width during the pre-stretching process. The film is stretched in a direction parallel to the film's length, this is called the machine direction (MD). During this stretching, there is a tendency for the film to contract or shrink in the direction perpendicular to the film length which is called transverse direction (TD).

The pre-stretching equipment is designed to minimize this neck-in. Accordingly, the thickness of the film is approximately decreased proportionally to the extent that the film is stretched. For example, a film that is stretched 300% or has a stretch ratio of 4:1 will have a thickness of approximately 25% (1:4) of the input film's thickness. In one embodiment, the input film has a thickness of between about 0.5 mil to about 2 mil (50 to 200 gauge) and the output film has a thickness of between about 0.2 mil to about 1 mil (20 to 100 gauge).

In illustrative embodiments, pre-stretching reduces the thickness of the film between about 25% to about 500% or using a draw ratio of between about 1.25:1 to about 6.00:1. In one embodiment, the stretch film is pre-stretched to between about 50% to about 350% or using a draw ratio of between about 1.50:1 to about 4.50:1. In another embodiment, the stretch film is pre-stretched to about 100% using a draw ratio of about 2:1.

In illustrative embodiments, the draw ratios influence the properties of a spherulite-like microcrystalline orientation differently than a row-nucleated microcrystalline orientation. For example, at low draw ratios, a spherulite-like microcrystalline orientation and a row-nucleated microcrystalline orientation may have TD tear resistance/MD tear resistance ratios which are close to 1. Because the films have a low draw ratio, there is relatively low orientation and the influence of the microcrystalline orientation is small. With higher draw ratios, the microcrystalline orientation influences the properties of the multi-layer film strongly. For example, spherulite-like microcrystalline orientations exhibits a higher TD tear resistance and a lower MD tear resistance. A row-nucleated microcrystalline orientation exhibits a lower TD tear resistance and a higher MD tear resistance. When a multi-layer film having both a layer including a spherulite-like microcrystalline orientation and a layer including a row-nucleating microcrystalline orientation, a surprising synergistic combination is achieved, wherein the gauge of the film can be substantially decreased while the MD tear resistance, TD tear resistance and puncture resistance can be substantially increased on a gauge-normalized basis.

The film has properties that make it useful for stretch-wrap packaging; particularly, the stretch film of the present disclosure exhibits improved load retention, puncture resistance, tear resistance, tensile strength, and/or cling properties. An example of the physical property changes which can occur through a pre-stretching process are provided in Tables 1 and 2.

TABLE 1
Properties of Input Films and Output Films

| | | Stretch | Dart Drop | Tear (MD) | Tear (TD) |
|---|---|---|---|---|---|
| Film | Gauge | Ratio | (g) | (g) | (g) |
| Input A | 120 | — | 225 | 309 | 1068 |
| #1 | 40 | 3:1 | 200 | 180 | 550 |
| #2 | 30 | 4:1 | 170 | 140 | 300 |
| Input B | 80 | — | 193 | 123 | 709 |
| #3 | 41 | 2:1 | 180 | 110 | 420 |
| #4 | 27 | 3:1 | 135 | 85 | 230 |

TABLE 2
Guage Normalized Properties of Input Films and Output Films

| | | Stretch | Dart Drop | Tear (MD) | Tear (TD) |
|---|---|---|---|---|---|
| Film | Gauge | Ratio | (g/mil) | (g/mil) | (g/mil) |
| Input A | 120 | — | 188 | 258 | 890 |
| #1 | 40 | 3:1 | 500 | 450 | 1375 |
| #2 | 30 | 4:1 | 567 | 467 | 1000 |
| Input B | 80 | — | 242 | 153 | 887 |
| #3 | 41 | 2:1 | 439 | 268 | 1024 |
| #4 | 27 | 3:1 | 500 | 315 | 852 |

The data in Tables 1 and 2 was obtained using a Dart Drop test (commonly described in ASTM D-1709), a Tear Test in the Machine Direction (commonly described in ASTM D-1922), and a Tear Test in the Traverse Direction (commonly described in ASTM D-1922). Each test was conducted at Berry Plastics facilities in Covington, Ga. Table 2 contains the same data presented in Table 1, except that the data was gauge normalized.

Exemplary films 1 and 2 were made from input film A and exemplary films 3 and 4 were made from input film B. Input film A was pre-stretched using a stretch ratio of 3:1 so that the film was pre-stretched 200% to make exemplary film 1. Input film A was pre-stretched using a stretch ratio of 4:1 so that the film was pre-stretched 300% to make exemplary film 2. Input film B was pre-stretched using a stretch ratio of 2:1 so that the film was pre-stretched 100% to make exemplary film 3. Input film B was pre-stretched using a stretch ratio of 3:1 so that the film was pre-stretched 200% to make exemplary film 4. Table 1 shows that the overall film properties decrease in response to the stretching, but the film thickness is also being reduced. The gauge normalized tear resistance (TD) is increased or remains about the same. Surprisingly, the gauge normalized the tear resistance (MD) and the puncture resistance both increased when the film was pre-stretched.

Furthermore, the data in Table 1 also shows that films having higher degrees of pre-stretching have better gauge normalized puncture and tear resistance than a film that was pre-stretched with a lower draw ratio. For example, exemplary film 1 is a 40 gauge film manufactured using a 3:1 draw ratio from a 120 gauge input film. The exemplary film 3 is similarly about a 40 gauge film, however it was manufactured using a 2:1 draw ratio from an 80 gauge input film. A comparison of the two films (having similar composition and gauge) reveals that exemplary film 1 had higher performance and strength characteristics in both the MD and TD tear strengths, which are greater by about 64% and 24%, respectively.

The performance characteristics of the films disclosed herein are surprising in light of other pre-stretched films now commercially available. For example, Table 3 shows exemplary film 5 compared to seven other pre-stretched films (comparative examples A through I).

TABLE 3

| | Example | Comparative Examples | | | | | | | |
|---|---|---|---|---|---|---|---|---|---|
| | 5 | A | B | C | D | E | F | G | I |
| Thickness (mil) | 0.33 | 0.35 | 0.30 | 0.35 | 0.30 | 0.35 | 0.35 | 0.35 | 0.35 |
| Dart Drop (g) | 150 | 67 | <60 | <60 | 73 | <60 | <60 | <60 | 71 |
| Tear MD (g) | 187 | 125 | 277 | 107 | 181 | 210 | 175 | 163 | 27 |
| Tear TD (g) | 400 | 366 | 336 | 432 | 389 | 360 | 335 | 360 | 405 |
| Cling In/Out (g) | 225 | 237 | 138 | 183 | 182 | 129 | 141 | 163 | 389 |

As can be seen from Table 3, each of the comparative examples have roughly the same thickness, yet the performance properties of the exemplary film is superior, at least in terms of puncture resistance (as measured by dart drop). Note that the dart drop is at least about two times greater than each of the comparative examples. In one embodiment, the pre-stretched multi-layer stretch film 100 has a gauge normalized puncture resistance of greater than or about 450 g/mil as determined by ASTM D-1709.

Furthermore, the tear resistance (TD) of the exemplary film is greater than or about equal to each of the comparative examples. The tear resistance (MD) of the exemplary film is greater than or about equal to most of the comparative examples, example B having higher tear resistance but low puncture resistance. Note that many of the comparative examples have puncture resistances which were too low to adequately determine through the dart drop analysis and are thus entered as <60 g.

TABLE 4

| | pre-heating | | | | cold-drawing | | | |
|---|---|---|---|---|---|---|---|---|
| | Sample # | | | | | | | |
| | 6 | 7 | 8 | 9 | 10 | 11 | 12 | 13 |
| Thickness (mil) | 0.38 | 0.36 | 0.32 | 0.32 | 0.46 | 0.46 | 0.36 | 0.38 |
| Dart Drop (g/mil) | 73.8 | 89.8 | 75.3 | 87.7 | 89 | 78.9 | 76.1 | 113.8 |
| Tear MD (g/mil) | 126.8 | 132.9 | 142.3 | 138.2 | 94 | 109.8 | 112.8 | 94.7 |
| Tear TD (g/mil) | 387.3 | 390.5 | 399.1 | 369.2 | 366.6 | 366.6 | 396.9 | 378.6 |
| Draw Ratio | 2.11 | 2.22 | 2.5 | 2.5 | 1.74 | 1.74 | 2.22 | 2.11 |

Table 4 shows a series of examples which represents the observed differences between films pre-stretched using a pre-heating process compared to those using a cold-drawing process. In samples 6-13, the puncture resistance may be superior by using a cold-drawing process compared to a pre-heating process. Furthermore, samples 6-13, the tear resistance (MD) may be superior by using a pre-heating process. Samples 6-13 also show that tear resistance (TD) appears to be equivalent for both the pre-heating and cold-drawing processes. In one embodiment, pre-heating and cold-drawing processes may both be performed on a given film.

While the foregoing is directed to embodiments of the present disclosure, other and further embodiments of the disclosure may be devised without departing from the basic scope thereof.

1. A pre-stretched multi-layer stretch film comprising
a cling layer, a non-cling layer, and a core layer interposed between the cling layer and the non-cling layer, wherein, the pre-stretched multi-layer stretch film has a gauge normalized puncture resistance greater than about two times the gauge normalized puncture resistance of an input film from which the pre-stretched multi-layer stretch film was derived.

2. The pre-stretched multi-layer stretch film of claim 1, wherein the core layer comprises a composition that resists row-nucleated microcrystalline orientation via rapid molecular relaxation.

3. The pre-stretched multi-layer stretch film of claim 1, wherein the core layer comprises a blend of LLDPE having a first MI of less than or about equal to 2.

4. The pre-stretched multi-layer stretch film of claim 3, wherein the blend of LLDPE includes about 80% to about 100% LLDPE having a second MI of less than or about equal to 1 and about 0% to about 20% LLDPE having a third MI of less than or about equal to 2.5.

5. The pre-stretched multi-layer stretch film of claim 3, wherein the blend of LLDPE includes about 90% LLDPE having a second MI of less than or about equal to 1 and about 10% LLDPE having a third MI of less than or about equal to 2.5.

6. The pre-stretched multi-layer stretch film of claim 5, wherein the non-cling layer comprises about 35% LDPE.

7. The pre-stretched multi-layer stretch film of claim 3, wherein the non-cling layer comprises from about 10% to about 50% LDPE, wherein the LDPE has a fourth MI of about 4 to about 8.

8. The pre-stretched multi-layer stretch film of claim 7, wherein the cling layer comprises an EMA copolymer.

9. The pre-stretched multi-layer stretch film of claim 7, wherein the cling layer comprises a blend LLDPE with a tackifier selected from an elastomer and a plastomer.

10. The pre-stretched multi-layer stretch film of claim 1, wherein the core layer is substantially free of a strain hardened polymer.

11. The pre-stretched multi-layer stretch film of claim 10, wherein the non-cling layer comprises from about 10% to about 50% of the strain hardened polymer.

12. The pre-stretched multi-layer stretch film of claim 1, wherein the core layer is substantially free of LDPE.

13. The pre-stretched multi-layer stretch film of claim 1, wherein the pre-stretched multi-layer stretch film has a gauge normalized puncture resistance of greater than or about 450 g/mil as determined by ASTM D-1709.

14. A pre-stretched multi-layer stretch film comprising a first exterior layer, a second exterior layer, and a core layer interposed between the first exterior layer and the second exterior layer, wherein, the first exterior layer has a first microcrystalline orientation and the core layer has a second microcrystalline orientation.

15. The pre-stretched multi-layer stretch film of claim 14, wherein the first microcrystalline orientation includes a row-nucleated microcrystalline orientation and the second microcrystalline orientation includes a microcrystalline orientation selected from a group consisting of spherulite-like or elongated spherulite-like.

16. The pre-stretched multi-layer stretch film of claim 15, wherein the first exterior layer comprises from about 10% to about 50% of a strain hardened polymer.

17. The pre-stretched multi-layer stretch film of claim 15, wherein the first exterior layer comprises a blend of LDPE and LLDPE.

18. The pre-stretched multi-layer stretch film of claim 17, wherein the blend of LDPE and LLDPE comprises about 35% LDPE and about 65% LLDPE by weight.

19. The pre-stretched multi-layer stretch film of claim 17, wherein the core layer is substantially free of LDPE.

20. The pre-stretched multi-layer stretch film of claim 14, wherein the pro-stretched multi-layer stretch film has a gauge normalized puncture resistance of greater than or about 450 g/mil as determined by ASTM D-1709.

21. A pre-stretched multi-layer stretch film comprising a first layer having a spherulite-like microcrystalline orientation and a second layer having a row-nucleated microcrystalline orientation, wherein the pre-stretched multi-layer stretch film has a gauge normalized puncture resistance greater than about 450 g/mil as determined by ASTM D-1709.

22. A pre-stretched multi-layer stretch film of claim 21, wherein the pre-stretched multi-layer stretch film includes about 80 to about 93% LLDPE, about 5 to about 8% LDPE, and about 2 to about 15% a cling promoting polymer.

23. The pre-stretched multi-layer stretch film of claim 22, wherein the cling promoting polymer is selected from a group consisting of an elastomer, a plastomer, and an EMA copolymer.

24. The pre-stretched multi-layer stretch film of claim 22, wherein the pre-stretched multi-layer stretch film is from about 0.10 mil to about 0.80 mil in thickness.

25. The pre-stretched multi-layer stretch film of claim 21, wherein the first layer includes less than 1% of a strain hardened polymer.

26. The pre-stretched multi-layer stretch film of claim 25, wherein the second layer includes about 10 to about 50% of the strain hardened polymer.

27. The pre-stretched multi-layer stretch film of claim 21, wherein the pre-stretched multi-layer stretch film is a pre-stretched machine-wrap film having an initial modulus and a later modulus after being stretched by about 50 to about 200%, wherein the later modulus is 50% greater than the initial modulus.

28. The pre-stretched multi-layer stretch film of claim 21, wherein the pre-stretched multi-layer stretch film is a pre-stretched band-wrap film having an initial modulus and a later modulus after being stretched by about 25 to about 50%, wherein the later modulus is 50% greater than the initial modulus.
